(19) United States
(12) Patent Application Publication
(10) Pub. No.: US 2015/0174010 A1
(43) Pub. Date: Jun. 25, 2015

(54) FEEDING BOTTLE

(71) Applicants: Ismail Ekmekci, Seyhan Adana (TR); Bulent Dikmen, Istanbul (TR)

(72) Inventors: Ismail Ekmekci, Seyhan Adana (TR); Bulent Dikmen, Istanbul (TR)

(21) Appl. No.: 14/416,587

(22) PCT Filed: Jul. 22, 2013
(86) PCT No.: PCT/TR2013/000227

§ 371 Date: Jan. 22, 2015

(30) Foreign Application Priority Data
Jul. 23, 2012 (TR) TR 2012/08550

(51) Int. Cl. A61J 9/00

(52) U.S. Cl. CPC A61J 9/00

(57) ABSTRACT

A feeding bottle can be filled with all kinds of food that is ready to be consumed and which can be used once or for a limited amount of time. It can be used for a limited amount of times or can be disposed of after it has been used. It can use the parts that are needed separately or together by means of the dummy and the feeding bottle being packaged together or separately. It protects the nutritional products from the lighting of the environment. Moreover the food can be made ready to be consumed by heating it with a heat source.

### TECHNICAL FIELD

The present invention is related to a feeding bottle which can be filled with all kinds of food that is ready to be consumed and which can be used once or for a limited amount of time.

### PRIOR ART

The feeding bottles used to feed babies have been designed to suit the oral structures and the feeding needs of babies. However the soft and deformable dummy part especially of the bottle wear's away in time or allows dents or protrusions to form which permit the accumulation of bacteria. The food which are left in room temperature or at temperatures higher than room temperature inside the feeding bottles cause bacteria formation in a short period of time. Moreover a meticulous effort needs to be shown in order to clean out the residues left inside the bottle after each usage. As babies are less resistant against microbes and bacteria the cleaning of their feeding apparatus needs maximum attention.

Nowadays disposable feeding bottles which have been also described in the international patent application numbered WO2011061367A1 are being used to feed babies. However their production costs are high and the area they consume during their storage conditions, said disposable bottles are not suitable to access wider masses.

### BRIEF DESCRIPTION OF THE INVENTION

The invention aims to improve a feeding bottle which allows it to be used for a limited amount of times or which can be disposed of after it has been used. The Invention further aims to be able to use the parts that are needed separately or together by means of the dummy and the feeding bottle to be packaged together or separately. The invention has the characteristics to protect the nutritional products from the lighting of the environment. Moreover it is also within the scope of the invention to make the food ready to be consumed by heating it with a heat source.

### DETAILED DESCRIPTION OF THE INVENTION

The feeding bottle provided in order to reach the aims of the invention has been shown in the attached figures wherein said figures illustrate the following;

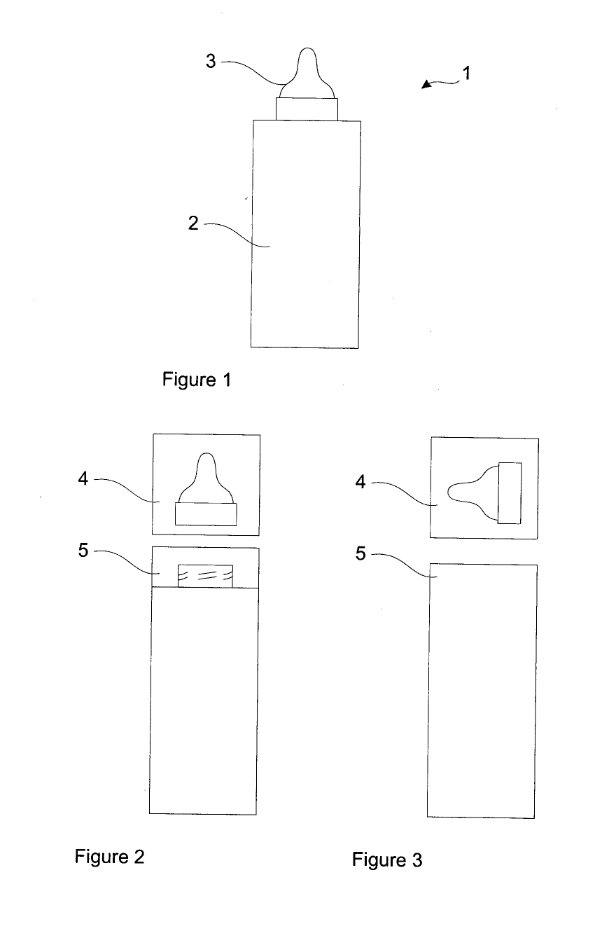

FIG. 1—Shows the side view of the feeding bottle subject to the invention.

FIG. 2—Is the side view of the closed dummy and bottle of the feeding bottle subject to the invention.

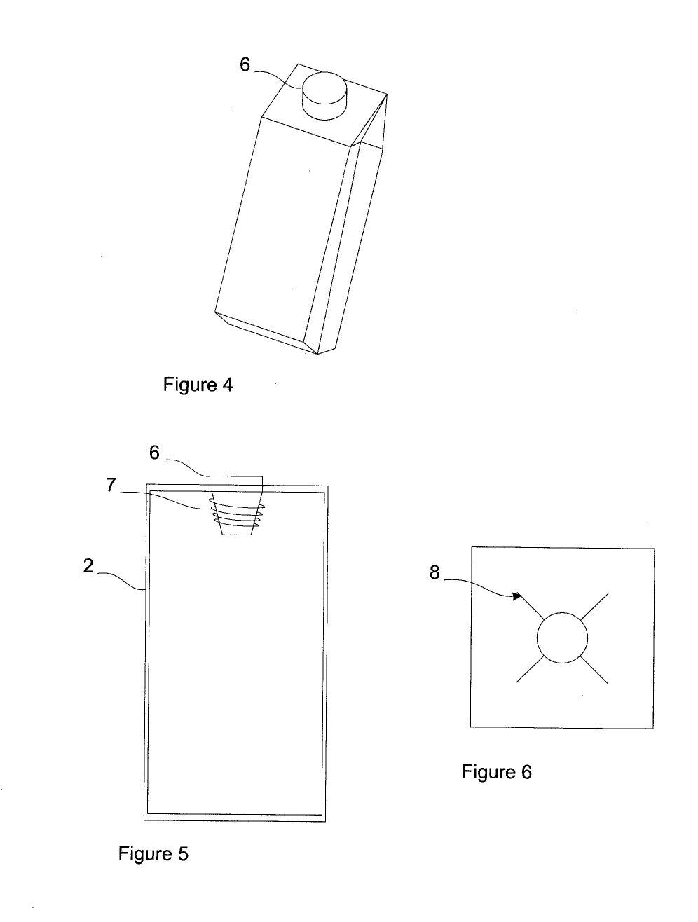

FIG. 3—Is the side perspective view of the half compressed state of the hollow application of the feeding bottle subject to the invention.

The parts in the figures have been numbered and the references of these numbers have been given below.

1. Feeding bottle

2. Bottle

3. Dummy

4. Packaged dummy

5. Packaged bottle

6. Dummy screw

7. Screw

8. Slit

The feeding bottle (1) subject to the invention basically comprises a bottle (2), a packaged dummy (4) which is the separately packed state of the dummy (3) and a packaged bottle (5). When the bottle (2) and the dummy (3) are coupled to each other the feeding bottle (1) is formed.

The feeding bottle (1) having parts which are ready to be used hygienically and within their package which are shaded from light can be used as soon as they are taken out of the package as opposed to the bottle (2) and dummies (3) which have been packed separately and which can already be found in the market. Nevertheless, it is possible to replace the packaged bottle (5) or the packaged dummy (4) with ones that have been worn out or that have been used or it is possible to use one of the old ones together with a new one. The invention also comprises packaged bottles (5) which contain food products inside them besides the dummy (3) and the bottle (2) packaged separately from each other in order to reach the aims of the invention described above. The bottle (2) is coated in the inside with a fluid conserving layer made of paper, carton, Styrofoam or a derivative type of material suitable to nutrition codex's of the ministry of health which does not let light in for all kinds of food products such as water, milk, fruit juice or baby food. As all of the dummy (3) is in contact with the baby, the packaged stage of the product covers all of the dummy (3). The packaged state of the bottle (2) however, is limited only with the dummy screw(6) with which the dummy (3) is screwed.

In the case that the food product inside the bottle (2) is a drink which can be kept as a cold drink, it is not healthy for the packaged bottle (5) which has been taken out of the refrigerator to be given to a baby directly. As the milk that needs to be warmed is still being sold in a different package to be heated and then poured into a bottle, this creates a need in terms of consumers. For this reason the bottle (2) has been produced by polygonal paper, carton, Styrofoam and derivative type materials in order for the bottle to look like a circular cross section or a circle.

When the bottle is full it is easier to keep its form when compared with the bottle being empty as the fluid inside applies an outward pressure. It is harder for bottles (2) which are empty to keep their forms. Moreover even though it is empty it is not suitable for each bottle (2) to occupy the same volume of space in terms of stocking costs. For this reason it is more suitable to package the empty bottles (2) at a compressed state.

It is possible to warm up all kinds of food products that need to be heated such as water, milk, fruit juice or baby food that shall be filled afterwards into the bottle (2) when being used out of said bottle (2). It is more suitable for the general application to be in this direction and at the same time for the empty bottle (2) to be circular or to have a polygonal cross section shape as the bottle (2) needs to be compressed when empty so that it occupies less space.

In order to compress and then later on open back the bottle, the dummy screw (6) located at the top part of the bottle (2) needs to be shifted to the side rather than being placed at the centre. In order for the bottle (2) to be suited with the width of the dummy screw (6) the top part of the bottle is shaped to fit the dummy screw (6). When it is at a compressed state, the packaged bottle (5) is formed by packing the top par of again the dummy screw (6) of the bottle (2) which takes up very little space.

By means of the screw (7) of the dummy screw (6) it is possible to attach the dummy screw such that it creates impermeability by providing slits on the bottle (2).

1. A feeding bottle comprising:
a packaged bottle where a dummy screw of a bottle is protected; and
a separately packaged dummy where a dummy is completely protected in order for the bottle to be able to be used and disposed of, or for the bottle to be used for a limited amount of time when feeding babies;
wherein the bottle has a circular cross section in order for the bottle to be able to be placed inside a heater, which is filled with all kinds of fluid food products and which is made of paper, carton or Styrofoam or derivative type of material which prevents the light from the environment to enter the bottle and which is coated with a fluid conserving layer at the inside.

2. A feeding bottle according to claim 1, characterized in that it comprises a dummy screw located between a connection area and a folding area, having a triangular section on top in order to fit the width of the dummy screw which has a polygonal or cylindrical section in order to be able to compress the hollow state of the bottle when there is no food inside it.
